(19) United States
(12) Patent Application Publication
(10) Pub. No.: US 2002/0090020 A1
(43) Pub. Date: Jul. 11, 2002

(54) Electronic thermometer

(75) Inventor: Chu-Yih Yu, Taipei Hsien (TW)

Correspondence Address: DOUGHERTY & TROXELL, Suite 1404, 5205 Leesburg Pike, Falls Church, VA, 22041, US

(73) Assignee: Mesure Technology Co., Ltd.

(21) Appl. No.: 09/756,656

(22) Filed: Jan. 10, 2001

(51) Int. Cl. G01K 1/08; G01K 7/00; G01K 1/16

(52) U.S. Cl. 374/208; 374/185

(57) ABSTRACT

A temperature detecting structure for electronic thermometer includes a thermometer shell having a tubular front extension end, two conductors arranged in parallel in the shell, a solid temperature tip fixedly fastened to the thermometer shell to close its tubular front extension end, and a chip connected to the conductors and fixedly mounted inside the solid temperature tip to directly receive heat from the solid temperature tip.

### BACKGROUND OF THE INVENTION

The present invention relates to an electronic thermometer, and more specifically to the arrangement of the temperature detecting structure for electronic thermometer.

FIGS. 1 and 2 show the arrangement of a temperature detecting structure for electronic thermometer according to the prior art. According to this arrangement, the temperature detecting structure comprises two conductors 2′, a chip 3′ embedded in a resin 4′ molded on the conductors 2′ at one end, a cap-like temperature tip 6′ fastened to the tubular front extension end 11′ of a thermometer shell 1′ and covered over the glue means 4′, and a heat conductive glue 5′, which adheres the resin 4′ to the inside wall of the temperature tip 6′. Because the resin 4′, the heat conductive glue 5′ and the temperature tip 6′ are of different materials, the transmission of heat from the patient's body to the chip 3′ through the temperature tip 6′, the heat conductive glue 5′ and the resin 4′ is slow. Further, an electronic thermometer made according to this design is complicated and expensive.

### SUMMARY OF THE INVENTION

The present invention has been accomplished under the circumstances in view. It is the main object of the present invention to provide a temperature detecting structure for electronic thermometer, which is simple and inexpensive to manufacture. According to the present invention, the temperature tip is a solid member fixedly fastened to the thermometer shell to close its the tubular front extension end, and the chip is connected to the conductors and fixedly mounted inside the solid temperature tip to directly receive heat from the solid temperature tip.

### BRIEF DESCRIPTION OF THE DRAWINGS

FIG. 1 is an exploded view of a temperature detecting structure for electronic thermometer according to the prior art.

FIG. 2 is a sectional assembly view of FIG. 1.

FIG. 3 is a perspective view of an electronic thermometer constructed according to the present invention.

FIG. 4 is an exploded view of the present invention.

FIG. 5 is a sectional assembly view of the present invention.

FIG. 6 shows a temperature detecting structure for electronic thermometer with a spherical temperature tip according to the present invention.

FIG. 7 shows a temperature detecting structure for electronic thermometer with a sector-like temperature tip according to the present invention.

FIG. 8 shows a temperature detecting structure for electronic thermometer with a cone-like temperature tip according to the present invention

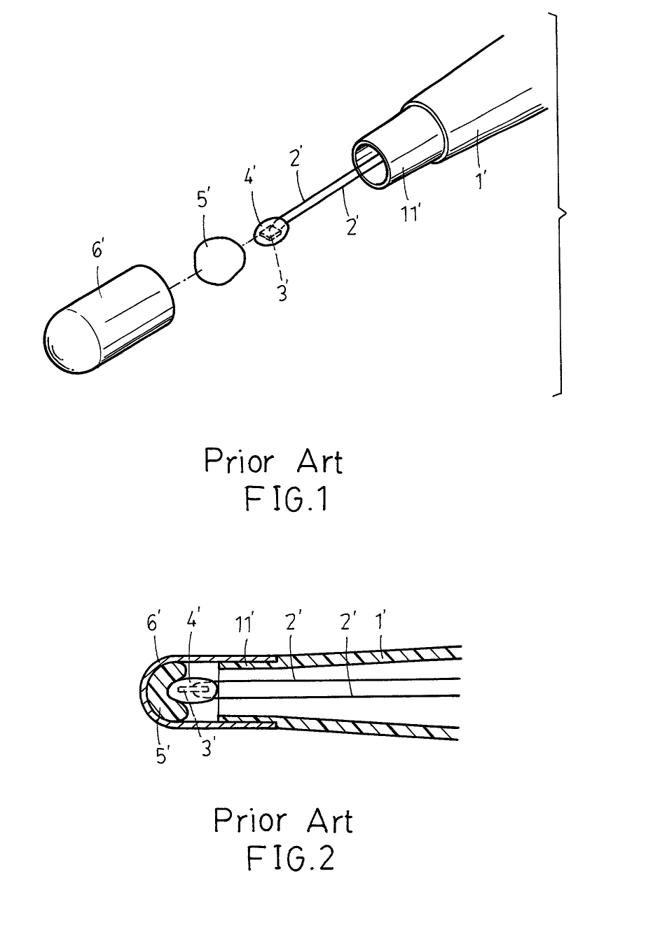

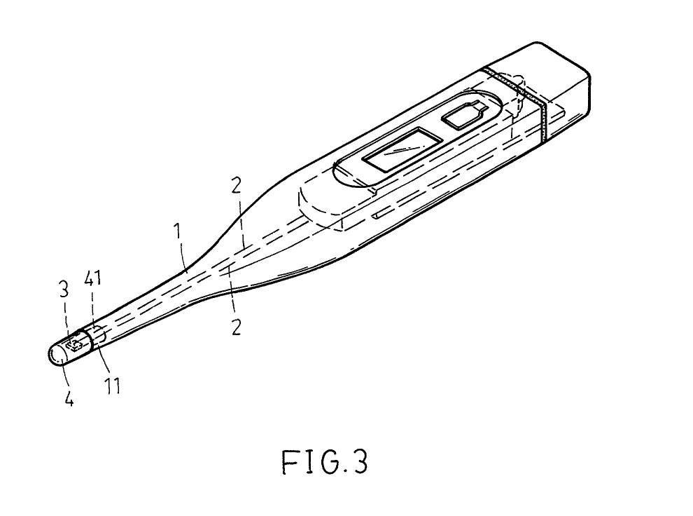

### DETAILED DESCRIPTION OF THE PREFERRED EMBODIMENT

Referring to FIGS. from 3 through 5, a temperature detecting structure for electronic thermometer is shown comprising two conductors 2 arranged in parallel in a thermometer shell 1, a chip 3 fastened to the conductors 2 at one end, namely, the front end, and a temperature tip 4 covered on the chip 3 and fastened to the tubular front extension end 11 of the shell 1. The temperature tip 4 is solid member made of non-toxic, impact resistant material. The chip 3 is fixedly fastened to the inside of the temperature tip 4 to directly receive heat from the temperature tip 4. After installation of the chip 3 in the temperature tip 4, the rear end of the temperature tip 4 is closed and fastened to the tubular front extension end 11 of the shell 1.

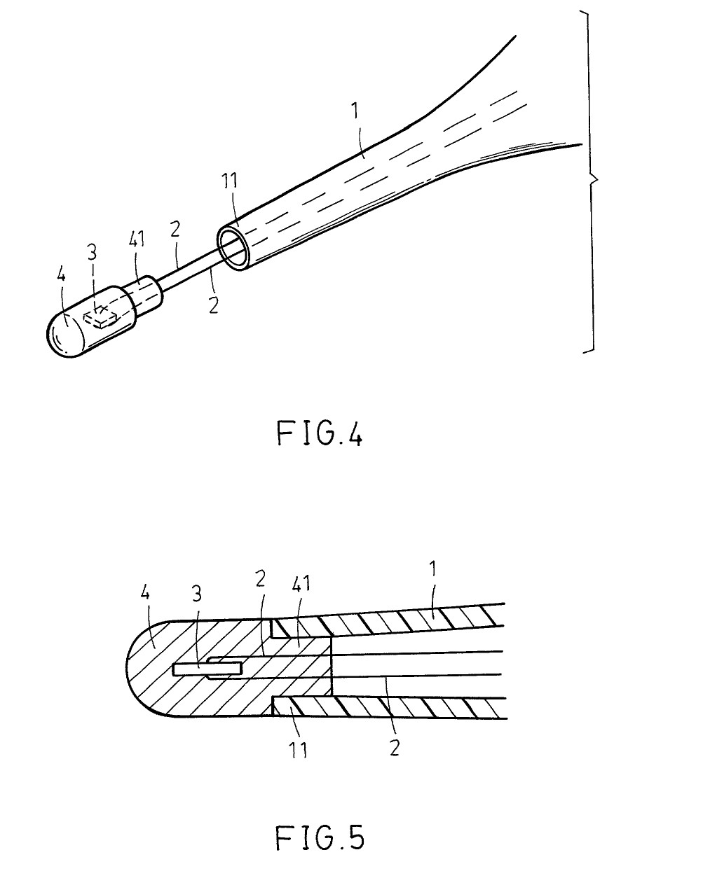

Referring to FIGS. 4 and 5 again, the temperature tip 4 has a rear end terminating in a plug portion 41 of reduced diameter pressed fitted into the tubular front extension end 11 of the shell 1 to reinforce the connection between the shell 1 and the temperature tip 4, and to simultaneously increase the contact area between the shell 1 and the temperature tip 4. The temperature tip 4 can be adhered to the shell 1 by glue, or fixedly secured thereto by a heat-sealing apparatus.

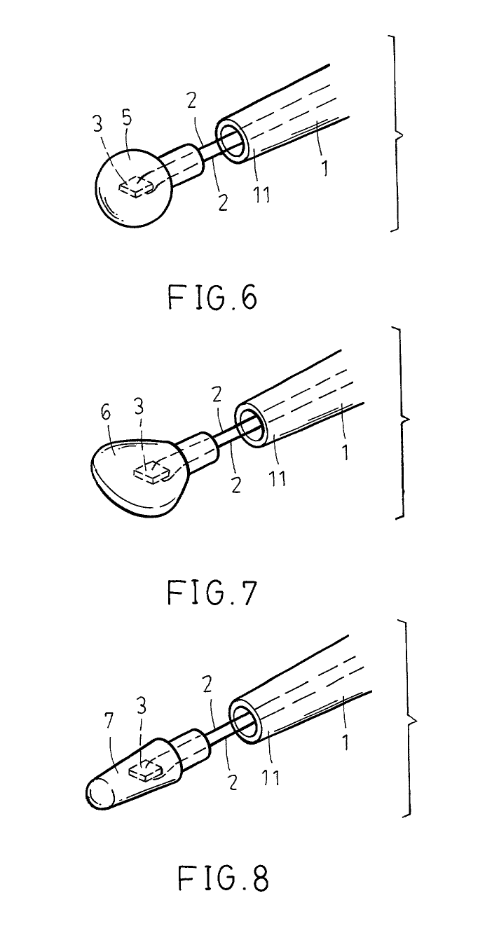

FIGS. from 6 through 8 show different alternate forms of the present invention. In FIG. 6, the temperature tip 5 has a spherical shape. In FIG. 7, the temperature tip 6 has a flat, sector-like shape. In FIG. 8, the temperature tip 7 has a shaped like a cone.

What the invention claimed is:

1. A temperature detecting structure for electronic thermometer comprising a thermometer shell having a tubular front extension end, two conductors arranged in parallel in said shell, a chip connected to said conductors at one end, and a temperature tip fastened to the tubular front extension end of said thermometer shell and adapted to transmit heat from the patient's body to said chip, wherein said temperature tip is a solid member made of non-toxic, impact resistant material and fastened to said thermometer shell to close said tubular front extension end of said thermometer shell, and said chip is fixedly fastened to the inside of said temperature tip to receive heat from said temperature tip directly.

2. The temperature detecting structure for electronic thermometer of claim 1, wherein said temperature tip comprises a rear plug portion press-fitted into said tubular front extension end of said thermometer shell.
